(19) United States
(12) Patent Application Publication
(10) Pub. No.: US 2026/0032634 A1
(43) Pub. Date: Jan. 29, 2026

(54) COMPLIANCE-ADAPTIVE SELECTION OF LOCATION DATA FROM MULTIPLE SOURCES FOR USER DEVICE LOCATION DETECTION FOR LOCATION-BASED SERVICES

(71) Applicant: DISH Wireless L.L.C., Englewood, CO (US)

(72) Inventors: Mehdi Alasti, Arlington, VA (US); Raghavendhra Rao, Littleton, CO (US); Adam Bensaid, Parker, CO (US)

(21) Appl. No.: 18/784,573

(22) Filed: Jul. 25, 2024

(51) Int. Cl. H04W 64/00; H04W 4/029

(52) U.S. Cl. CPC H04W 64/006; H04W 4/029

(57) ABSTRACT

Systems and methods for dynamically selecting location source data to improve overall location accuracy compliance for location-based services of network user devices. Horizontal location data and vertical location data for the user device are obtained from multiple sources. A horizontal location uncertainty and a vertical location uncertainty are determined or obtained for each source. An a-posteriori horizontal compliance is determined for each corresponding source based on a combination of an a-priori horizontal compliance and a horizontal compliance value representing compliance of the horizontal location uncertainty for the corresponding source. An a-posteriori vertical compliance is determined for each corresponding source based on a combination of an a-priori vertical compliance and a vertical compliance value representing compliance of the vertical location uncertainty for the corresponding source. The sources are then down-selected based on the a-posteriori horizontal and vertical compliances for each corresponding source in view of horizontal and vertical compliance thresholds.

### BACKGROUND

Mobile phones are being used more and more by more and more people. As the use of mobile phones has increased, so too has the need to make 911 calls from mobile phones. The speed at which emergency services can respond to a 911 call relies on identifying the caller's location. Unfortunately, many callers are unable to provide their location. As a result, the Federal Communications Commission has required cellular service providers to obtain and provide the mobile phone's location to the emergency services within a certain level of accuracy. Similarly, many mobile phones have other applications or other services that rely on or use location information. But mobile phones can be unreliable in providing or obtaining accurate location information. It is with respect to these and other considerations that the embodiments described herein have been made.

### BRIEF SUMMARY

Embodiments are directed towards systems and methods for dynamically selecting location source data to improve overall location accuracy compliance for location-based services of user devices of a network. Horizontal location data and vertical location data for a user device are obtained from each of the plurality of sources. A horizontal location uncertainty of the horizontal location data is determined for each corresponding source, and a vertical location uncertainty of the vertical location data is determined for each corresponding source. A horizontal compliance value is generated for each corresponding source by employing horizontal decision parameters on the horizontal location uncertainty for the corresponding source relative to a threshold horizontal uncertainty. Similarly, a vertical compliance value is generated for each corresponding source by employing vertical decision parameters on the vertical location uncertainty of the corresponding source relative to a threshold vertical uncertainty. An a-posteriori horizontal compliance is determined for each corresponding source based on a combination of an a-priori horizontal compliance and the horizontal compliance value for the corresponding source. Similarly, an a-posteriori vertical compliance is determined for each corresponding source based on a combination of an a-priori vertical compliance and the vertical compliance value for the corresponding source. The plurality of sources are then down-selected based on the a-posteriori horizontal compliance and the a-posteriori vertical compliance for each corresponding source in view of a horizontal compliance threshold and a vertical compliance threshold. In some embodiments, horizontal location data and vertical location data from a source from the down-selected sources may be selected as captured location data for the user device for the location-based service based on the threshold horizontal uncertainty and the threshold vertical uncertainty.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically selecting location source data to improve overall location accuracy compliance for location-based services of user devices (e.g., 911 calls) in accordance with embodiments described herein;

FIGS. 2 and 3 are context diagrams of non-limiting embodiments of systems that provide functionality to dynamically obtain and select location source data to improve overall location accuracy compliance for location-based services in accordance with embodiments described herein;

FIGS. 4A-4C illustrate a logical flow diagram showing one embodiment of a process for dynamically obtaining and selecting location source data to improve overall location accuracy compliance for location-based services in accordance with embodiments described herein;

FIGS. 5A and 5B illustrate a logical flow diagram showing one embodiment of a process for down-selecting location sources based on the compliance of each source in accordance with embodiments described herein; and

FIG. 6 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

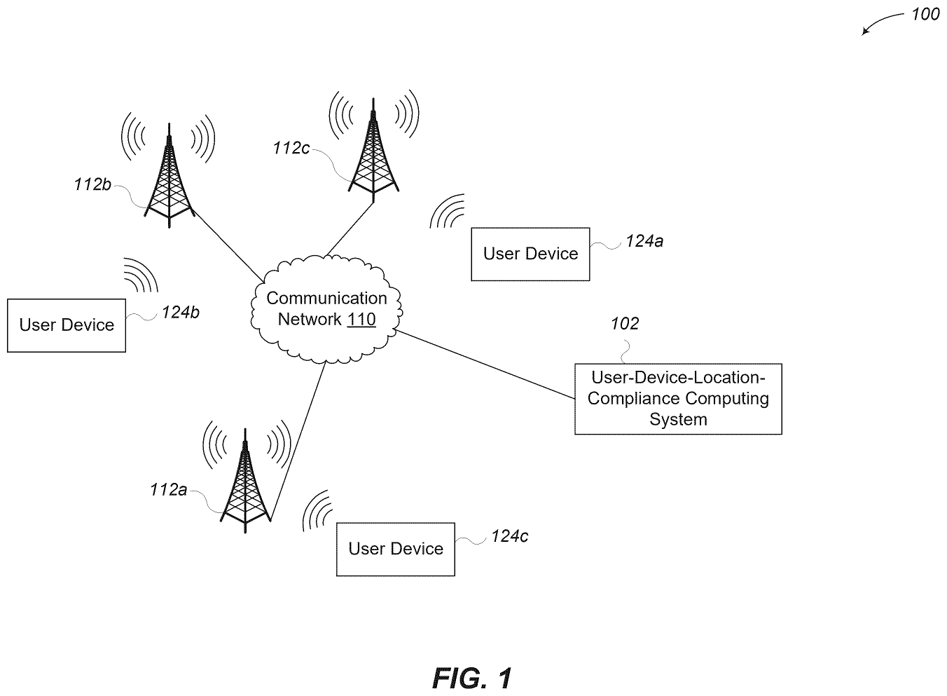

FIG. 1 illustrates a context diagram of an environment 100 for dynamically selecting location source data to improve overall location accuracy compliance for location-based services of user devices (e.g., 911 calls) in accordance with embodiments described herein. Environment 100 includes a plurality of cells 112a-112c, a plurality of user devices 124a-124c, a user-device-location-compliance computing system 102, and a communication network 110.

The cells 112a-112c are cellular towers that together provide the hardware infrastructure of a cellular communications network, e.g., a 5G cellular communications network. The cells 112a-112c may include or be in communication with base stations, radio backhaul equipment, antennas, or other devices, which are not illustrated for case of discussion. In various embodiments, the cells 112a-112c may communicate with each other via communication network 110. Communication network 110 includes one or more wired or wireless networks, which may include a series of smaller or private connected networks that carry information between the cells 112a-112c.

The user devices 124a-124c are computing devices that utilize at least one location-based service. User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can utilize a location-based service. As one illustrative example, user devices 124a-124c may be mobile devices that are configured to receive and transmit cellular communications with the cells 112a-112c.

In some embodiments, the user devices 124a-124c may be configured to transmit location data indicating a location of the user device when using a location-based service. This location includes horizontal location data (x/y-axis) and vertical location data (z-axis). In various embodiments, the location data may also include horizontal location uncertainty and vertical location uncertainty data. For example, in some embodiments, the user devices 124a-124c may be configured to transmit emergency calls to a 911 dispatcher (not illustrated). The dispatcher (or PSAP) generally relies on the accuracy of this location data to quickly dispatch emergency services to the user device's location. Emergency calls, also referred to as 911 calls or e911 calls, are phone calls or messages, or other emergency communications, made from user devices 124 to a 911 dispatcher. Other computing devices, servers, or systems (not illustrated) may also receive and utilize location data provided by the user devices 124a-124c.

For a cellular communications network to be certified for handling 911 calls, it generally must comply with certain accuracy requirements when reporting the location of the user device 124 that is making a 911 call. For example, the Federal Communications Commission (FCC) has set certification requirements to verify the accuracy of the user device location data being collected from the user device 124. Currently, the FCC requires a cellular communications network to show that it can provide horizontal location data with an accuracy of 50 meters (i.e., the reported horizontal location data must be within a radius of 50 meters of the actual horizontal location of the user device making the 911 call) and vertical location data with an accuracy of 3.0 (three) meters (i.e., the reported vertical location data must be plus or minus 3.0 meters of the actual vertical location of the user device making the 911 call) for 80% of all wireless 911 calls placed. Although FCC rules are discussed herein, other location accuracy regulatory requirements, rules, or benchmarks may be utilized for different location-based services. Accordingly, some location-based services (or devices) may utilize broader benchmarks, whereas other location-based services (or devices) may utilized more accurate benchmarks.

Unfortunately, there are a number of reasons why it can be very difficult for the cellular communication network to verify the accuracy of 911 calls. For example, user devices can utilize or collect its location data from one or a plurality of sources. But the accuracy of these sources may change due to multiple variables, including, but not limited to, the location of the user device, physical objects obstructing wireless signals, radio frequency interference, technology limitations, or other location-collection inaccuracies. And because FCC rules require cellular communications networks to process 911 calls for all user devices, not just those user devices that have a service plan or are members of the mobile communications network, the cellular communications network cannot guarantee the accuracy of all location data of all 911 calls. In addition, there is no known (“ground-truth”) location data external to a device placing a 911 call, so there is no way to verify the actual location of a 911 call in real time. As a result, the cellular communications networks test location data at known locations for a plurality of simulated 911 calls across various morphologies in order to confirm in a test environment that location data reported by the user device or the cellular communications network are accurate within FCC (or other regulatory authorities) standards when deployed in real-world environments. By utilizing embodiments described herein, the user-device-location-compliance computing system 102 analyzes location data from a plurality of sources for location-based services to capture sufficient location data for the cellular communications network to meet current accuracy-compliance requirements.

The user-device-location-compliance computing system 102 is a server, computing device, cloud computing environment, or some other computing system configured to receive location data from a plurality of sources for a plurality of location-based services (e.g., 911 calls) used by user devices 124a-124c and determine if which location sources to use to improve overall compliance with location accuracy requirements. The location data may be from use of actual location-based services (e.g., actual 911 calls) or simulated used of location-based services (e.g., simulated 911 calls). The user-device-location-compliance computing system 102 analyzes the horizontal location data (also referred to as horizontal positioning data) and the vertical location data (also referred to a vertical positioning data) from each source of each location-based service usage to determine which location sources improve the system's compliance.

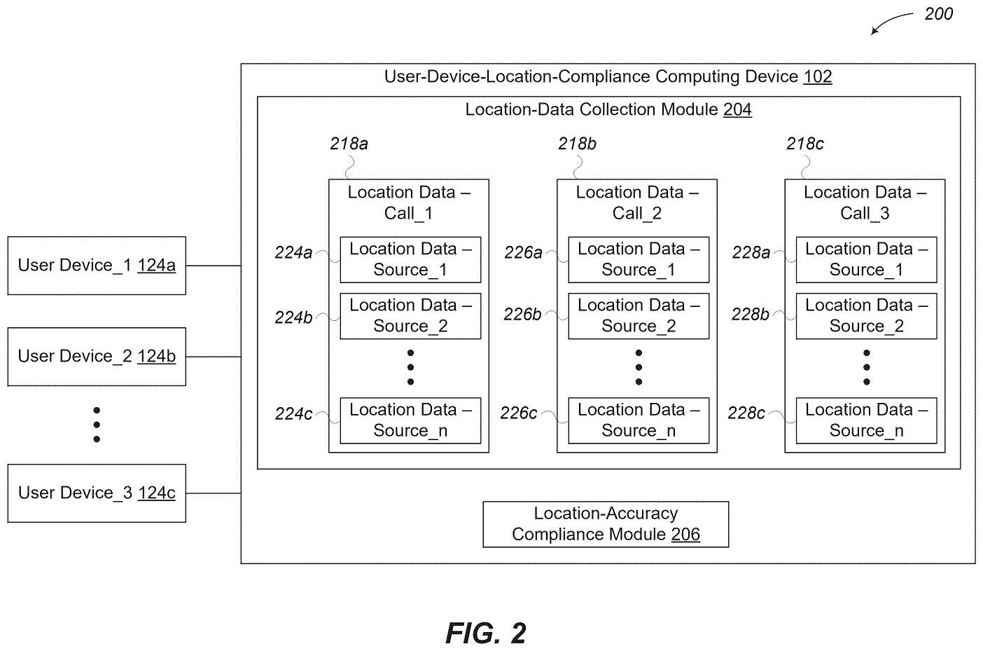

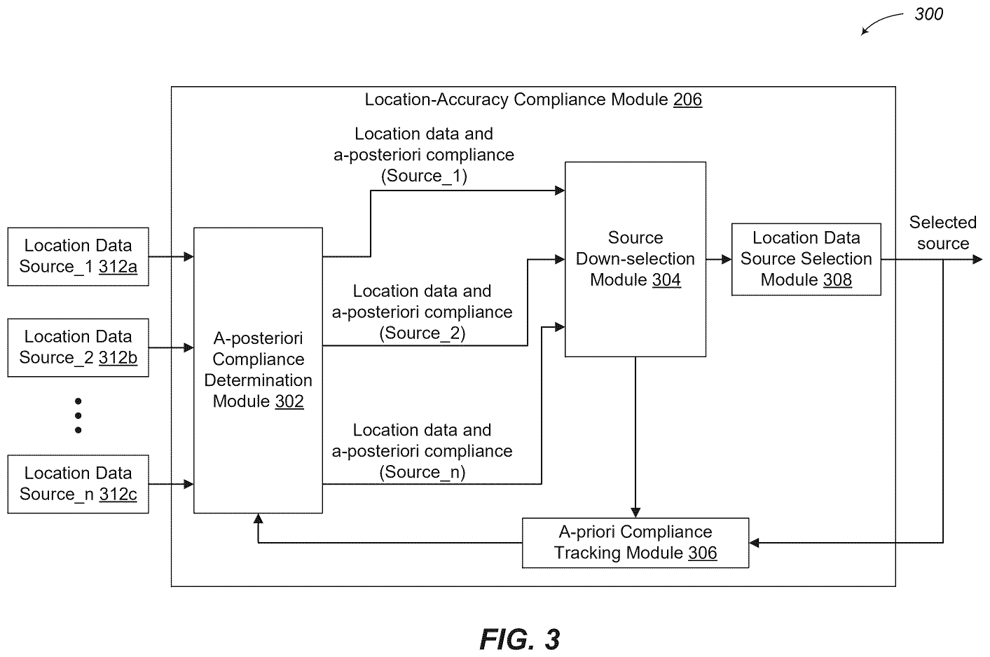

FIGS. 2 and 3 are context diagrams of non-limiting embodiments of systems that provide functionality to dynamically obtain and select location source data to improve overall location accuracy compliance for location-based services in accordance with embodiments described herein. FIG. 2 is a context diagram of a non-limiting embodiment of systems that provide functionality to dynamically obtain and select location source data for location-based services in accordance with embodiments described herein. Example 200 includes a user-device-location-compliance computing device 102 and a plurality of user devices 124a-124c, similar to FIG. 1. The user devices 124a-124c may be separate or distinct user devices using location-based services from a plurality of known locations, or they may be the same user device making separate uses of location-based services calls from the plurality of known locations, or they may be separate or distinct user devices using location-based services from a plurality of known locations.

The user-device-location-compliance computing device 102 includes a location-data collection module 204 and a location-accuracy compliance module 206. The location-data collection module 204 generates, determines, collects, or obtains location data 218a-218c from a plurality of location sources associated with a plurality of uses of location-based services (e.g., a plurality of 911 calls being made) by user devices 124a-124c. The location data 218a-218c from one or more sources may include horizontal location data (the horizontal position of the user device on the Earth) or vertical location data (the altitude or elevation of the user device relative to the Earth), or a combination thereof.

The location sources from which location data 218a-218c is determined or obtained may include horizontal location sensors or systems that capture horizontal location data of a user device at the time of a use of the location-based service and vertical location sensors or systems to capture vertical location data of the user device at the time of the use of the location-based service. Examples of horizontal location sensors or systems may include, but are not limited to, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other horizontal positional sensors (e.g., accelerometers or gyroscopes), or the like), cell tower triangulation, cell identification (e.g., a location of the cell tower in which the user device is communicating), enhanced cell identification (e.g., a relative direction or distance from the location of the cell tower in which the user device is communicating and few neighboring cell towers in which the user device can measure their received power), or other systems configured to capture a horizontal location of a user device making a call. Examples of vertical location sensors or systems may include, but are not limited to, Global Positioning System (GPS) data, Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other vertical positional sensors (e.g., accelerometers or gyroscopes), barometric positioning sensors, or the like), barometric sensor, enhanced barometric sensor (e.g., biometric sensor data calibrated to the horizontal location of the user device or to the current weather at the horizontal location of the user device), crowdsourced data based on known Wi-Fi hot spots, RF finger-printing, beacons, or other systems configured to capture a vertical location of the user device making the call. Other types of positioning features, capabilities and positioning methods may also be used to provide or enhance location data, including for example, downlink time difference of arrival (DL-TDoA), uplink time difference of arrival (UL-TDoA), multi-cell round-trip time (MC-RTT), downlink angle of departure (DL-AoD), uplink angle of arrival (UL-AoA), Carrier Phase, positioning reference units with a known position to the network, etc.

Accordingly, the location sources may be some combination of location sources on or employed by the user devices 124a-124c or determined by the mobile-device-location-compliance computing device 102 separate or independent of the user devices, or a hybrid location system that utilizes a combination of information provided by the user devices and generated by the network. Thus, the user devices may generate and provide some location source data and the network (e.g., the mobile-device-location-compliance computing device 102) may generate or determine other location source data (e.g., without the user device providing location data).

Once obtained, the location-data collection module 204 stores the location data 218a-218c of user devices 124a-124c associated with a plurality of location-based service uses. In this example, the location-data collection module 204 stores location data 218a of a user device (e.g., user device 124a) for a first 911 call, location data 218b of a user device (e.g., user device 124b) for a second 911 call, and location data 218c of a user device (e.g., user device 124c) for a third 911 call. The illustrative storage of 911 calls is not limiting and other location-based service uses of user devices 124a-124c may also be stored.

The location data 218a for the first call includes location data 224a from a first source, location data 224b from a second source, and location data 224c from a third source. The location data 224a-224c from the separate sources may include horizontal location data, vertical location data, or a combination of both. The location data 218b for the second call includes location data 226a from a first source, location data 226b from a second source, and location data 226c from a third source. The location data 224a-224c from the separate sources may include horizontal location data, vertical location data, or a combination of both. The location data 218c for the third call includes location data 228a from a first source, location data 228b from a second source, and location data 228c from a third source. The location data 224a-224c from the separate sources may include horizontal location data, vertical location data, or a combination of both. Although location data 224a-224c, location data 226a-226c, and location data 228a-228c are from a “first source,” a “second source,” and a “third source,” the “first sources” may be the same source or different sources, the “second sources” may be the same source or different sources, and the “third sources” may be the same source or different sources. Accordingly, the various location data for the separate calls made by the user devices may be from the same, similar, or different sources.

The location-accuracy compliance module 206 is discussed in more detail with respect to FIGS. 3, 4A-4C, 5A, and 5B. Briefly, however, the location-accuracy compliance module 206 is configured to perform embodiments described herein to analyze the location data from a plurality of source to dynamically select which location source or sources can be used in selecting the location data for a user device using a location-based service, which allows for the location-accuracy compliance module 206 to improve the overall accuracy of the wireless environment to meet location accuracy compliance requirements.

FIG. 3 is a further context diagram of non-limiting embodiments of systems that provide functionality to dynamically obtain and select location source data to improve overall location accuracy compliance for location-based services in accordance with embodiments described herein.

Example 300 includes the location-accuracy compliance module 206 from FIG. 2 and location data 312a-312b. For case of illustration, the location data 312a-312b may be the location data 224a-224c from call 218a in FIG. 2.

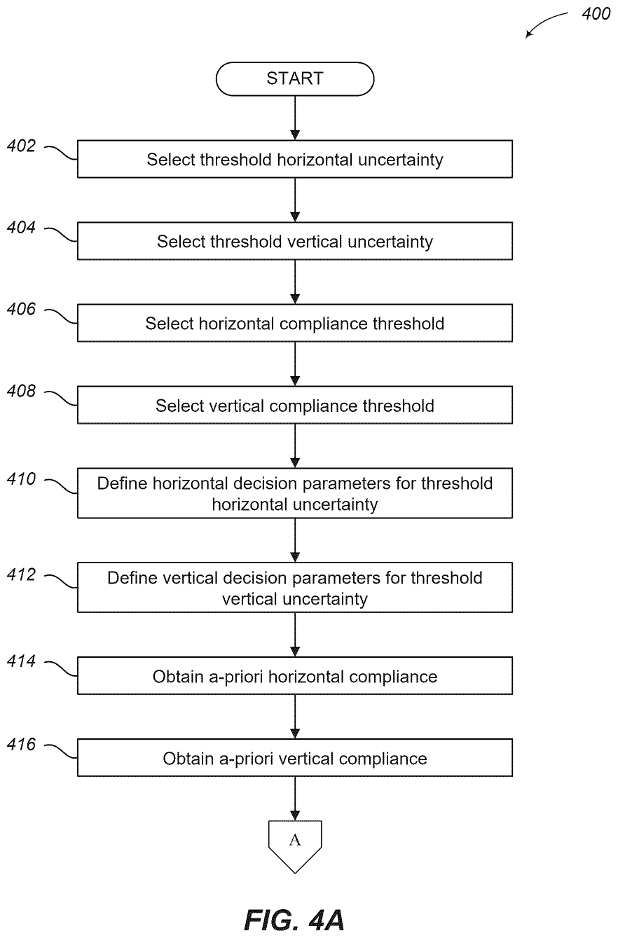

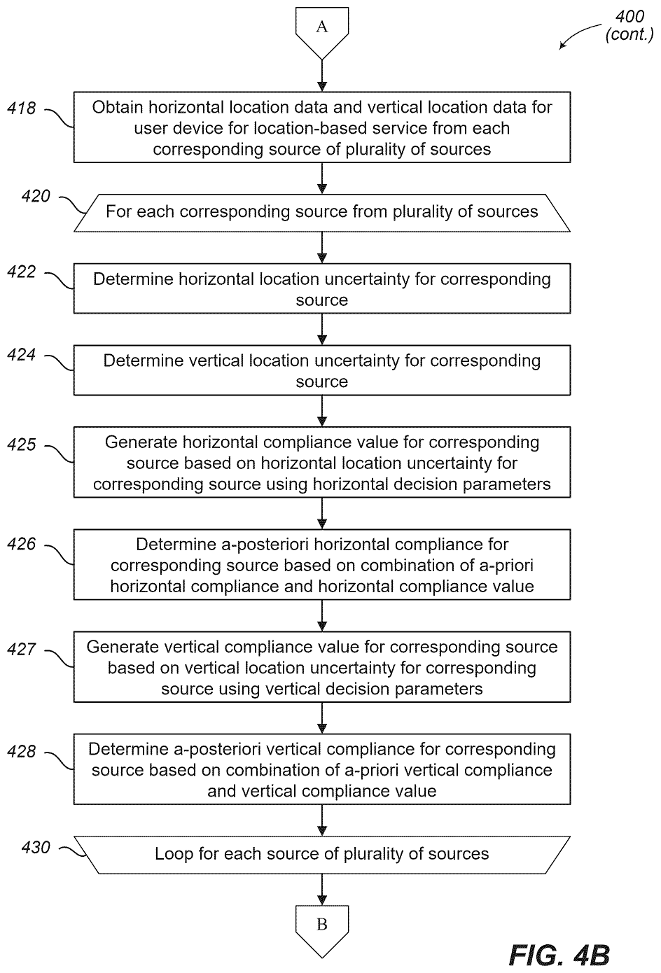

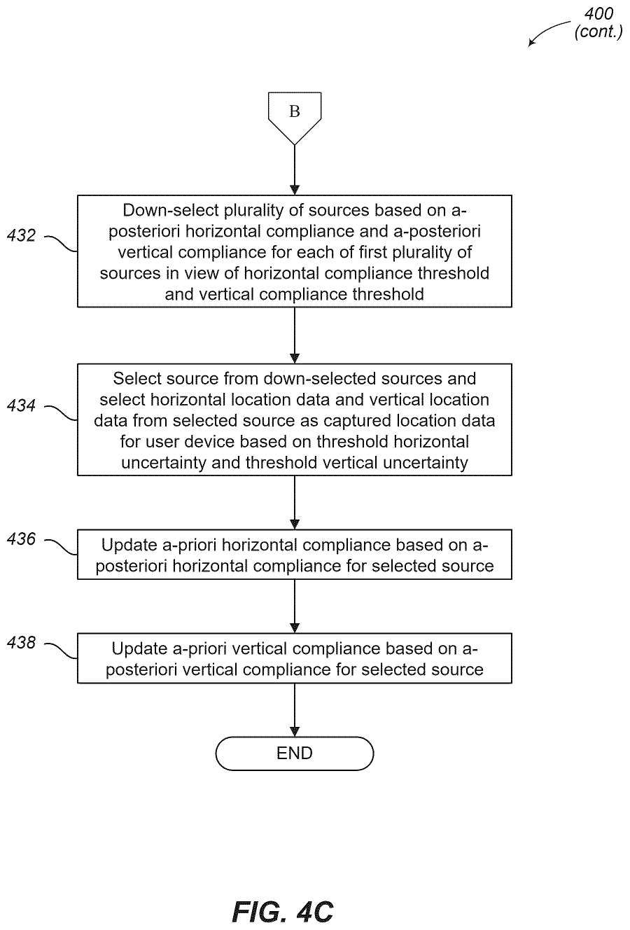

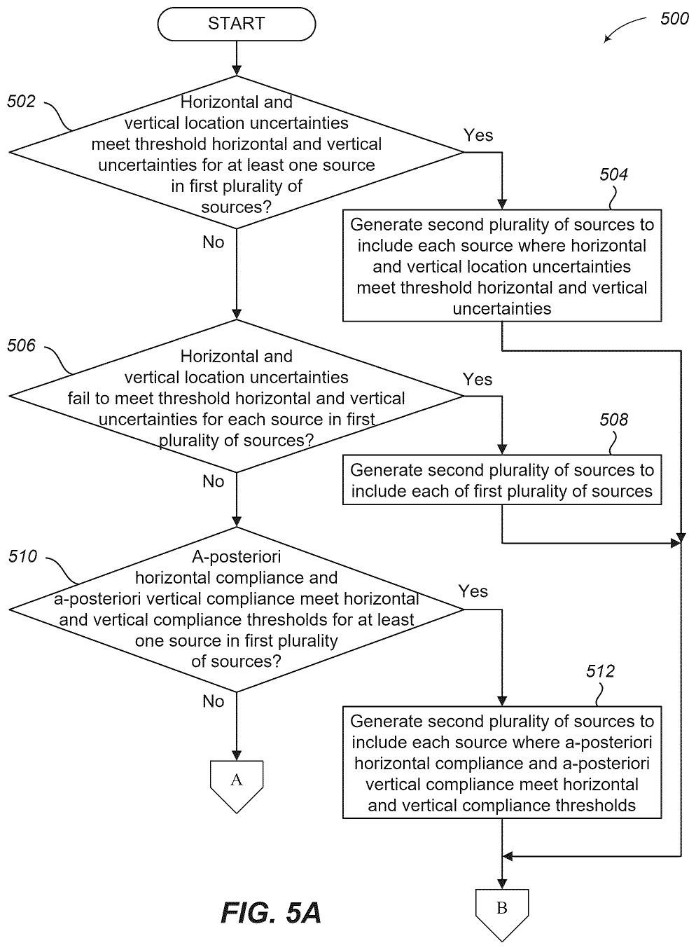

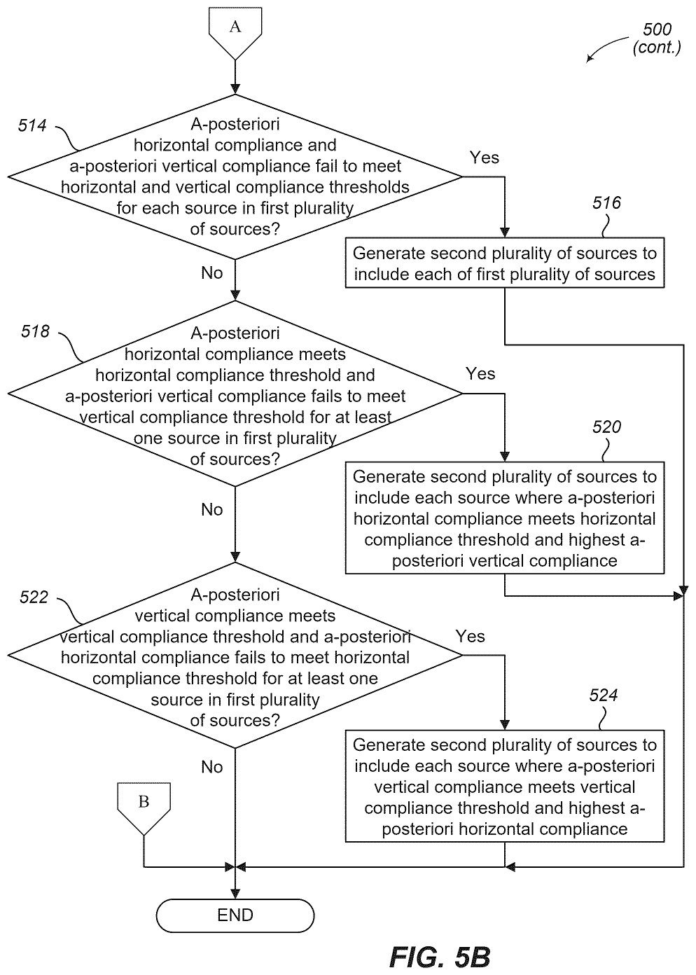

The location-accuracy compliance module 206 may be configured to perform functionality described herein, including process 400 in FIGS. 4A-4C and process 500 in FIGS. 5A and 5B. The location-accuracy compliance module 206 may include an a-posteriori compliance determination module 302, a source-down-selection module 304, an a-priori compliance tracking module 306, and a location data source selection module 308. Although the a-posteriori compliance determination module 302, the source-down-selection module 304, the a-priori compliance tracking module 306, and the location data source selection module 308 are illustrated as separate modules, embodiments are not so limited. Rather one module or a plurality of modules may be employed to perform the functionality of the a-posteriori compliance determination module 302, the source-down-selection module 304, the a-priori compliance tracking module 306, and the location data source selection module 308. These modules may be software, hardware, or some combination thereof that together perform the functionality described herein.

The a-posteriori compliance determination module 302 is configured to receive location data 312a-312c from a plurality of sources for a user device using a location-based service. In this illustrative example, location data 312a is from a first source, location data 312b is from a second source, and location data 312c is from a third source. As described herein, the location data 312a-312c from each source may include horizontal location data and vertical location data, where the horizontal location data for a corresponding source may include a corresponding horizontal location of the user device and a corresponding horizontal location uncertainty for that corresponding horizontal location, and the vertical location data for a corresponding source may include a corresponding vertical location of the user device and a corresponding vertical location uncertainty for that corresponding vertical location.

The a-posteriori compliance determination module 302 is configured to determine an a-posteriori horizontal compliance and an a-posteriori vertical compliance for each source location data 312a-312c based on the a-priori horizontal compliance and the a-priori vertical compliance maintained or tracked by the a-priori compliance tracking module 306, as described herein (e.g., at blocks 416 and 428 in FIG. 4B).

The source-down-selection module 304 is configured to receive the location data 312a-312c and the corresponding a-posteriori horizontal and vertical compliances for those sources from the a-posteriori compliance determination module 302. In some embodiments, the source-down-selection module 304 may receive or obtain the location data 312a-312c independent of the a-posteriori compliance determination module 302. The source-down-selection module 304 is then configured to select one or more sources from which to provide to the location data source selection module 308. The source-down-selection module 304 may employ embodiments of process 500 in FIGS. 5A and 5B to generate the down-selected sources.

The a-priori compliance tracking module 306 is configured to track the overall horizontal compliance and the overall vertical compliance of the system as sources are selected for user devices using location-based services. The a-priori compliance tracking module 306 receives the a-posteriori horizontal compliance and the a-posteriori vertical compliance for each source that is included in the down-selected sources generated by the source down-selection module 304. The a-priori compliance tracking module 306 also receives an indication from the location data source selection module 308 identifying which source was selected as the horizontal and vertical location data for the user device. The a-priori compliance tracking module 306 can then store or update the a-priori horizontal compliance and the a-priori vertical compliance based on the a-posteriori horizontal compliance and the a-posteriori vertical compliance of the selected source.

The location data source selection module 308 is configured to analyze the location data from the down-selected sources to dynamically select location data for a user device using a location-based service, which allows for the location data source selection module 308 to determine if the location reporting meets location accuracy compliance requirements, such as described at block 434 in FIG. 4C. The location data source selection module 308 can provide the selected source, and the selected horizontal and vertical location data to another device or system for the user device using the location-based service.

FIGS. 4A-4C illustrate a logical flow diagram showing one embodiment of a process 400 for dynamically obtaining and selecting location source data to improve overall location accuracy compliance for location-based services (e.g., 911 calls) in accordance with embodiments described herein. In at least one of various embodiments, process 400 may be implemented by or executed via circuitry or on one or more computing devices, such as user-device-location-compliance computing device 102 in FIGS. 1 and 2. In general process 400 may be employed to dynamically obtain and select location source data for location-based services, devices, or systems, such as, but not limited to, 911 calls, law enforcement devices and tracking, gaming applications, social media applications, etc.

Process 400 begins, after a start block in FIG. 4A, at block 402, where a threshold horizontal uncertainty is selected. The threshold horizontal uncertainty is a threshold distance at which the horizontal location uncertainty is to not exceed in any horizontal direction away from the actual location of a user device. In at least one embodiment, the horizontal location uncertainty is a distance value in meters indicating how far off the horizontal location data from a source is from the actual horizontal location, or an estimate of how far off the corresponding source calculates the horizontal location data to be from the actual horizontal location. In some embodiments, the threshold horizontal uncertainty may be set as a current FCC horizontal uncertainty requirement, such as 50 meters. In other embodiments, other threshold horizontal uncertainty distances may be selected.

Process 400 continues, after block 402, at block 404, where a threshold vertical uncertainty is selected. The threshold vertical uncertainty is a threshold distance at which the vertical location uncertainty is to not exceed in either vertical direction away from the actual location of a user device. In at least one embodiment, the vertical location uncertainty is a distance value in meters indicating how far off the vertical location data from a source is from the actual vertical location, or an estimate of how far off the corresponding source calculates the vertical location data to be from the actual vertical location. In some embodiments, the threshold vertical uncertainty may be set as a current FCC vertical uncertainty requirement, such as 3.0 meters. In other embodiments, other threshold vertical uncertainty distances may be selected.

Process 400 proceeds, after block 404, to block 406, where a horizontal compliance threshold is selected. In various embodiments, the horizontal compliance threshold is a value or accuracy percentage of location data provided by a plurality of user devices that meet the threshold horizontal uncertainty. In some embodiments, the horizontal compliance threshold may be set as a current FCC horizontal compliance requirement, such that at least 80 percent of location-based data (e.g., as provided by a plurality of 911 calls) has location data that meet the 50 meter threshold horizontal uncertainty requirement. In other embodiments, other horizontal compliance thresholds may be selected.

Process 400 continues, after block 406, at block 408, where a vertical compliance threshold is selected. In various embodiments, the vertical compliance threshold is a value or accuracy percentage of location data provided by a plurality of user devices that meet the threshold vertical uncertainty. In some embodiments, the vertical compliance threshold may be set as a current FCC vertical compliance requirement, such that at least 80 percent of location-based data (e.g., as provided by a plurality of 911 calls) has location data that meet the 3.0 meter threshold vertical uncertainty requirement. In other embodiments, other vertical compliance thresholds may be selected.

Process 400 proceeds, after block 408, to block 410, where horizontal decision parameters are defined for the horizontal location uncertainty of location sources. In some embodiments, the horizontal decision parameters are Boolean flag decisions, such that if the horizontal location uncertainty for a given source meets the threshold horizontal uncertainty, then the Boolean flag is “true.” But if the horizontal location uncertainty for a given source fails to meet the threshold horizontal uncertainty, then the Boolean flag is “false.” Other types of horizontal decision parameters may be defined to track or monitor whether the horizontal location uncertainty for a given source meets the threshold horizontal uncertainty.

Process 400 continues, after block 410, at block 412, where vertical decision parameters are defined for the vertical location uncertainty of location sources. In some embodiments, the vertical decision parameters are Boolean flag decisions, such that if the vertical location uncertainty for a given source meets the threshold vertical uncertainty, then the Boolean flag is “true.” But if the vertical location uncertainty for a given source fails to meet the threshold vertical uncertainty, then the Boolean flag is “false.” Other types of vertical decision parameters may be defined to track or monitor whether the vertical location uncertainty for a given source meets the threshold vertical uncertainty.

Process 400 proceeds, after block 412, to block 414, where an a-priori horizontal compliance is obtained. The a-priori horizontal compliance is the current aggregated horizontal compliance for horizontal location uncertainties meeting the threshold horizontal uncertainty for previously obtained horizontal location data for a plurality of user devices prior to receipt of horizontal location uncertainty data for a next user device. In various embodiments, the a-priori horizontal compliance may be referred to as the running or aggregate horizontal compliance as of the most recent horizontal location uncertainty obtained for a previous user device. In other words, the a-priori horizontal compliance tracks how close the aggregated horizontal location uncertainty for a plurality of user devices is to the horizontal compliance threshold.

Process 400 continues, after block 414, at block 416, where an a-priori vertical compliance is obtained. The a-priori vertical compliance is the current aggregated vertical compliance for vertical location uncertainties meeting the threshold vertical uncertainty for previously obtained vertical location data for a plurality of user devices prior to receipt of vertical location uncertainty data for a next user device. In various embodiments, the a-priori vertical compliance may be referred to as the running or aggregate vertical compliance as of the most recent vertical location uncertainty obtained for a previous user device. In other words, the a-priori vertical compliance tracks how close the aggregated vertical location uncertainty for a plurality of user devices is to the vertical compliance threshold.

Process 400 proceeds, after block 416, to block 418 in FIG. 4B, where horizontal location data and vertical location data are obtained from each corresponding source of a plurality of sources for a user device that is utilizing a location-based service (e.g., making a 911 call). The horizontal location data for a corresponding source may include a corresponding horizontal location of the user device and a corresponding horizontal location uncertainty for that corresponding horizontal location. And the vertical location data for a corresponding source may include a corresponding vertical location of the user device and a corresponding vertical location uncertainty for that corresponding vertical location.

As described herein, the location data may be generated and provided by location sources on or employed by the user device, or the location data may be generated or determined by the network itself, or generated using a hybrid system, or some combination thereof. In some embodiments, the horizontal location data and vertical location data from a plurality of sources can be provided to a location engine for processing.

Process 400 continues, after block 418, to block 420, where each corresponding source is selected from the plurality of sources to be processed.

For each corresponding source, process 400 proceeds, after block 420, to block 422, where a horizontal location uncertainty is determined for the corresponding source. In various embodiments, the horizontal location uncertainty is obtained with the horizontal location data at block 418. As discussed herein, the horizontal location uncertainty is a distance value indicating how far off the horizontal location is from an actual horizontal location of the user device, or an estimate of how far off the corresponding source calculates the horizontal location to be from the actual horizontal location of the user device.

Process 400 proceeds, after block 422, to block 424, where a vertical location uncertainty is determined for the corresponding source. In various embodiments, the vertical location uncertainty is obtained with the vertical location data at block 418. In at least one embodiment, the vertical location uncertainty is a distance value indicating how far off the vertical location is from an actual vertical location of the user device, or an estimate of how far off the corresponding source calculates the vertical location to be from the actual vertical location of the user device.

Process 400 continues, after block 424, at block 425, where a horizontal compliance value is generated for the corresponding source based on the horizontal location uncertainty for corresponding source using the horizontal decision parameters. As noted above, the horizontal decision parameters may include Boolean flag decisions such that if the horizontal location uncertainty for the corresponding source meets the threshold horizontal uncertainty, then the Boolean flag is “true” and the horizontal compliance value is set to one (i.e., the corresponding source is identified as meeting the threshold horizontal uncertainty). But if the horizontal location uncertainty for the corresponding source fails to meet the threshold horizontal uncertainty, then the Boolean flag is “false” and the horizontal compliance value is set to zero (i.e., the corresponding source is identified as failing to meet the threshold horizontal uncertainty).

Process 400 continues, after block 425, at block 426, where an a-posteriori horizontal compliance is determined for the corresponding source. The a-posteriori horizontal compliance is a hypothetical horizontal compliance determination assuming the corresponding source is selected for the horizontal location of the user device. The a-posteriori horizontal compliance is determined from a combination of the a-priori horizontal compliance and the horizontal compliance value for the correspondence source. The average compliance rate is determined from the a-priori horizontal compliance with the identification of the corresponding source meeting or failing to meet the threshold horizontal uncertainty.

The following are mathematical representations of embodiments described herein for determining the a-posteriori horizontal compliance for the corresponding source for the user device using the location-based service.
T is the current instance of location data from multiple location sources for the user device using the location-based service;
i is a given location source for the location-based service of the user device, where i=1, . . . , K) for K plurality of location data sources;
H_{Uncer}_{ᵢ}(T) is the horizontal location uncertainty for a given location source i;
H_{F_i}(T) is the result of the horizontal decision parameters for the given location source i, where,

$${H}_{F\_i} ( T ) = \{ \begin{matrix}1 & if {H}_{{Uncer}_{i}} ( T ) < threshold horizontal uncertainty ( e . g . , 50 meters ) \\ 0 & Otherwise\end{matrix} ;$$

N is the number of horizontal location data points for a plurality of user devices using the location-based service;
H_{%} is the horizontal compliance percentage of N horizontal location data meeting the threshold horizontal uncertainty, with the target of having H_{%} being greater than or equal to the horizontal compliance threshold (e.g., H_{%}≥80%);
H_{%}(T-1) is the a-priori horizontal compliance percentage of previously selected horizontal location data meeting the threshold horizontal uncertainty; and
H_{%}(T) is the a-posteriori horizontal compliance percentage assuming the hypothetical selection of the location source i is selected as the location source of the horizontal location data of the user device for the location-based service.
   The a-posteriori horizontal compliance for the corresponding can be determined by:

$${H}_{\% \_ i} ( T ) = \frac{N - 1}{N} {H}_{\%} ( T - 1 ) + \frac{1}{N} {H}_{F\_i} ( T ) ;$$

In other embodiments, the a-posteriori horizontal compliance for the corresponding source can be determined by:

$${H}_{\% \_ i} ( T ) = \frac{1}{N} {\sum }_{t = T - N + 1}^{T} {H}_{F\_i} ( t )$$

Process 400 continues, after block 426, at block 427, where a vertical compliance value is generated for the corresponding source based on the vertical location uncertainty for corresponding source using the vertical decision parameters. As noted above, the vertical decision parameters may include Boolean flag decisions such that if the vertical location uncertainty for the corresponding source meets the threshold vertical uncertainty, then the Boolean flag is “true” and the vertical compliance value is set to one (i.e., the corresponding source is identified as meeting the threshold vertical uncertainty). But if the vertical location uncertainty for the corresponding source fails to meet the threshold vertical uncertainty, then the Boolean flag is “false” and the vertical compliance value is set to zero (i.e., the corresponding source is identified as failing to meet the threshold vertical uncertainty).

Process 400 continues, after block 427, at block 428, where an a-posteriori vertical compliance is determined for the corresponding source. The a-posteriori vertical compliance is a hypothetical vertical compliance determination assuming the corresponding source is selected for the vertical location of the user device. The a-posteriori vertical compliance is determined from a combination of the a-priori vertical compliance and the vertical location uncertainty for the correspondence source using or applying the vertical decision parameters. The average compliance rate is determined from the a-priori vertical compliance with the identification of the corresponding source meeting or failing to meet the threshold vertical uncertainty.

The following are mathematical representations of embodiments described herein for determining the a-posteriori vertical compliance for the corresponding source for the user device using the location-based service.
T is the current instance of location data from multiple location sources for the user device using the location-based service;
i is a given location source for the location-based service of the user device, where i=1, . . . , K) for K plurality of location data sources; V_{Uncer}_{ᵢ}(T) is the vertical location uncertainty for a given location source i;
V_{F_i}(T) is the result of the vertical decision parameters for the given location source i, where,

$${V}_{F\_i} ( T ) = \{ \begin{matrix}1 & if {V}_{{Uncer}_{i}} ( T ) < threshold vertical uncertainty ( e . g . , \pm 3 meters ) \\ 0 & Otherwise\end{matrix} ;$$

M is the number of vertical location data points for a plurality of user devices using the location-based service;
V_{%} is the vertical compliance percentage of M vertical location data meeting the threshold vertical uncertainty, with the target of having V_{%} being greater than or equal to the vertical compliance threshold (e.g., V_{%}≥80%);
V_{%}(T-1) is the a-priori vertical compliance percentage of previously selected vertical location data meeting the threshold vertical uncertainty;
V_{%}(T) is the a-posteriori vertical compliance percentage assuming the hypothetical selection of the location source i is selected as the location source of the vertical location data of the user device for the location-based service.
   The a-posteriori vertical compliance for the corresponding source can be determined by:

$${V}_{\% \_ i} ( T ) = \frac{M - 1}{M} {V}_{\%} ( T - 1 ) + \frac{1}{M} {V}_{F\_i} ( T ) ;$$

In other embodiments, the a-posteriori vertical compliance for the corresponding source can be determined by:

$${V}_{\% \_ i} ( T ) = \frac{1}{M} {\sum }_{t = T - M + 1}^{T} {V}_{F\_i} ( t )$$

Process 400 proceeds, after block 428, to block 430, which loops to block 420 to process each corresponding source to determine an a-posteriori horizontal compliance and an a-posteriori vertical compliance for that corresponding source.

After block 430, process 400 continues at block 432 in FIG. 4C.

At block 432 in FIG. 4C, the plurality of sources are down-selected, which is further described in conjunction with FIG. 5. Briefly, however, the plurality of sources are down-selected to include those sources that meet certain criteria relative the threshold horizontal and vertical uncertainties or the a-posteriori horizontal compliance and the a-posteriori vertical compliance in view of the horizontal compliance threshold and the vertical compliance threshold.

Process 400 continues, after block 432, at block 434, where a source from the down-selected sources is selected using a source selection mechanism. The horizontal location data and vertical location data from the selected source is then be selected as the captured location data for the user device based on the threshold horizontal uncertainty and threshold vertical uncertainty. Examples of the source selection mechanism are described in U.S. patent application Ser. No. 18/610,060, filed on Mar. 19, 2024; U.S. patent application Ser. No. 18/610,063, filed on Mar. 19, 2024; and U.S. patent application Ser. No. 18/610,066, filed on Mar. 19, 2024; each of which are incorporated herein in their entirety.

Process 400 proceeds, after block 434, to block 436, where the a-priori horizontal compliance is updated with the a-posteriori horizontal compliance calculated at block 426 for the corresponding source selected at block 434. In some embodiments, if the location source i is selected as the horizontal location data for the user device using the location-based service, then H_{%_i}(T) is stored as the a-priori horizontal compliance for the next instance of location data for a user device using the location-based service.

Process 400 continues, after block 436, at block 436, where the a-priori vertical compliance is updated with the a-posteriori vertical compliance calculated at block 428 for the corresponding source selected at block 434. In some embodiments, if the location source i is selected as the vertical location data for the user device using the location-based service, then V_{%_i}(T) is stored as the a-priori vertical compliance for the next instance of location data for a user device using the location-based service.

After block 436, process 400 terminates or otherwise returns to a calling process to perform other actions. In some embodiments, process 400 may loop (not illustrated) from block 436 in FIG. 4C to block 418 in FIG. 4B to obtain horizontal location data and vertical location data as a next instance of location data for a user device (which may be the same or separate user device as previously processed) using the location-based service.

FIGS. 5A and 5B illustrate a logical flow diagram showing one embodiment of a process 500 for down-selecting location sources based on the compliance of each source in accordance with embodiments described herein. In at least one of various embodiments, process 500 may be implemented by or executed via circuitry or on one or more computing devices, such as user-device-location-compliance computing device 102 in FIGS. 1 and 2.

Process 500 begins, after a start block, at decision block 502 in FIG. 5A, where a determination is made whether the horizontal location uncertainty meets the threshold horizontal uncertainty and the vertical location uncertainty meets the threshold vertical uncertainty for at least one source in the plurality of sources obtained for the user device using the location-based service. In various embodiments, the horizontal location uncertainty and the vertical location uncertainty of each source are compared to the threshold horizontal uncertainty and the threshold vertical uncertainty, respectively.

In some embodiments, the horizontal location uncertainty may be considered as meeting the threshold horizontal uncertainty if the horizontal location uncertainty is within a set amount of the threshold horizontal uncertainty (e.g., the horizontal location uncertainty exceeds the threshold horizontal uncertainty by no more than 2 meters). Similarly, in some embodiments, the vertical location uncertainty may be considered as meeting the threshold vertical uncertainty if the vertical location uncertainty is within a set amount of the threshold vertical uncertainty (e.g., the vertical location uncertainty exceeds the threshold vertical uncertainty by no more than 0.5 meters).

If at least one source meets both threshold uncertainties, then process 500 flows to block 504; otherwise, process 500 flows decision block 506.

At block 504, the down-selected sources is generated to include each source where the horizontal location uncertainty meets the threshold horizontal uncertainty and the vertical location uncertainty meets the threshold vertical uncertainty. After block 504, process 500 terminates or otherwise returns to a calling process to perform other actions.

If, at decision block 502, no source both has a horizontal location uncertainty that meets the threshold horizontal uncertainty and a vertical location uncertainty that meets the threshold vertical uncertainty, then process 500 flows from decision block 502 to decision block 506. At decision block 506, a determination is made whether the horizontal location uncertainty fails to meet the threshold horizontal uncertainty and the vertical location uncertainty fails to meet the threshold vertical uncertainty for each source in the plurality of sources. In various embodiments, the horizontal location uncertainty and the vertical location uncertainty of each source are compared to the threshold horizontal uncertainty and the threshold vertical uncertainty, respectively. If no sources meet both threshold uncertainties, then process 500 flows to block 508; otherwise, process 500 flows decision block 510.

At block 508, the down-selected sources is generated to include each source from the plurality of sources. After block 508, process 500 terminates or otherwise returns to a calling process to perform other actions.

If, at decision block 506, no source both has a horizontal location uncertainty that fails to meet the threshold horizontal uncertainty and a vertical location uncertainty that fails to meet the threshold vertical uncertainty, then process 500 flows from decision block 506 to decision block 510. In other words, process 500 flows from decision block 506 to decision block 510 when each source has a horizontal location uncertainty that meets the threshold horizontal uncertainty but a vertical location uncertainty that fails to meet the threshold vertical uncertainty, or a vertical location uncertainty that meets the threshold vertical uncertainty but a horizontal location uncertainty that fails to meet the threshold horizontal uncertainty, but not both.

At decision block 510, a determination is made whether the a-posteriori horizontal compliance meets the horizontal compliance threshold and the a-posteriori vertical compliance meets the vertical compliance threshold for at least one source in the plurality of sources. In various embodiments, the a-posteriori horizontal compliance and the a-posteriori vertical compliance of each source are compared to the horizontal compliance threshold and the vertical compliance threshold, respectively.

In some embodiments, the a-posteriori horizontal compliance may be considered as meeting the horizontal compliance threshold if the a-posteriori horizontal compliance is within a set amount of the horizontal compliance threshold (e.g., the a-posteriori horizontal compliance is less than the horizontal compliance threshold by no more than 3%). Similarly, in some embodiments, the a-posteriori vertical compliance may be considered as meeting the vertical compliance threshold if the a-posteriori vertical compliance is within a set amount of the vertical compliance threshold (e.g., the a-posteriori vertical compliance is less than the vertical compliance threshold by no more than 3%).

If at least one source meets both compliance thresholds, then process 500 flows to block 512; otherwise, process 500 flows decision block 514 in FIG. 5B.

At block 512, the down-selected sources is generated to include each source where the a-posteriori horizontal compliance meets the horizontal compliance threshold and the a-posteriori vertical compliance meets vertical compliance threshold. After block 512, process 500 terminates or otherwise returns to a calling process to perform other actions.

If, at decision block 510, no source both has an a-posteriori horizontal compliance that meets the horizontal compliance threshold and an a-posteriori vertical compliance that meets the vertical compliance threshold, then process 500 flows from decision block 510 to decision block 514 in FIG. 5B. At decision block 514, a determination is made whether the a-posteriori horizontal compliance fails to meet the horizontal compliance threshold and the a-posteriori vertical compliance fails to meet the vertical compliance threshold for each source in the plurality of sources. In various embodiments, the a-posteriori horizontal compliance and the a-posteriori vertical compliance of each source are compared to the horizontal compliance threshold and the vertical compliance threshold, respectively. If the a-posteriori compliances for no sources meet both compliance thresholds, then process 500 flows to block 516; otherwise, process 500 flows decision block 518.

At block 516, the down-selected sources is generated to include each source from the plurality of sources. After block 516, process 500 terminates or otherwise returns to a calling process to perform other actions.

If, at decision block 514, no source both has an a-posteriori horizontal compliance that fails to meet the horizontal compliance threshold and an a-posteriori vertical compliance that fails to meet the vertical compliance threshold, then process 500 flows from decision block 514 to decision block 518. In other words, process 500 flows from decision block 514 to decision block 518 when each source has an a-posteriori horizontal compliance that meets the horizontal compliance threshold but an a-posteriori vertical compliance that fails to meet the vertical compliance threshold, or an a-posteriori vertical compliance that meets the vertical compliance threshold but an a-posteriori horizontal compliance that fails to meet the horizontal compliance, but not both.

At decision block 518, a determination is made whether the a-posteriori horizontal compliance meets the horizontal compliance threshold and the a-posteriori vertical compliance fails to meet the vertical compliance threshold for at least one source in the plurality of sources. In various embodiments, the a-posteriori horizontal compliance and the a-posteriori vertical compliance of each source are compared to the horizontal compliance threshold and the vertical compliance threshold, respectively. In some embodiments, the a-posteriori horizontal compliance may be considered as meeting the horizontal compliance threshold if the a-posteriori horizontal compliance is within a set amount of the horizontal compliance threshold (e.g., the a-posteriori horizontal compliance is less than the horizontal compliance threshold by no more than 3%). If the a-posteriori horizontal compliance for at least one sources meets the horizontal compliance threshold but the a-posteriori vertical compliance for that source does not meet the vertical compliance threshold, then process 500 flows to block 520; otherwise, process 500 flows decision block 522.

At block 520, the down-selected sources is generated to include each source where the a-posteriori horizontal compliance meets the horizontal compliance threshold and has a highest a-posteriori vertical compliance. In some embodiments, a number of sources having a highest a-posteriori vertical compliance may be selected, such as the five sources having a highest a-posteriori vertical compliance and an a-posteriori horizontal compliance that meets the horizontal compliance threshold. After block 520, process 500 terminates or otherwise returns to a calling process to perform other actions.

If, at decision block 518, no source has an a-posteriori horizontal compliance that meets the horizontal compliance threshold and an a-posteriori vertical compliance that fails to meet the vertical compliance threshold, then process 500 flows from decision block 518 to decision block 522. At decision block 522, a determination is made whether the a-posteriori vertical compliance meets the vertical compliance threshold and the a-posteriori horizontal compliance fails to meet the horizontal compliance threshold for at least one source in the plurality of sources. In various embodiments, the a-posteriori horizontal compliance and the a-posteriori vertical compliance of each source are compared to the horizontal compliance threshold and the vertical compliance threshold, respectively. In some embodiments, the a-posteriori vertical compliance may be considered as meeting the vertical compliance threshold if the a-posteriori vertical compliance is within a set amount of the vertical compliance threshold (e.g., the a-posteriori vertical compliance is less than the vertical compliance threshold by no more than 3%).

In some situations, no source may satisfy the decision blocks in FIG. 5 if the data is null, determined to be unreliable (e.g., if the location data between sources differ by some threshold amount), or if there is missing location data from one or more sources. In such a situation, the down-selected sources include each source from the plurality of sources or the down-selected sources may include no sources.

If the a-posteriori vertical compliance for at least one source meets the vertical compliance threshold but the a-posteriori horizontal compliance for that source does not meet the horizontal compliance threshold, then process 500 flows to block 524; otherwise, process 500 terminates or otherwise returns to a calling process to perform other actions.

At block 524, the down-selected sources is generated to include each source where the a-posteriori vertical compliance meets the vertical compliance threshold and has a highest a-posteriori horizontal compliance. In some embodiments, a number of sources having a highest a-posteriori horizontal compliance may be selected, such as the five sources having a highest a-posteriori horizontal compliance and an a-posteriori vertical compliance that meets the vertical compliance threshold. After block 524, process 500 terminates or otherwise returns to a calling process to perform other actions.

In some embodiments, the order in which decision blocks 518 and 522 are processed may be different from what is shown. For example, in some embodiments decision block 522 may be proceeded first to determine if at least one source has an a-posteriori vertical compliance that meets the vertical compliance threshold and an a-posteriori horizontal compliance that fails to meet the horizontal compliance threshold. If no source meets this criteria, then process 500 may flow to decision block 518 to determine if at least one source has an a-posteriori horizontal compliance that meets the horizontal compliance threshold and an a-posteriori vertical compliance that fails to meet the vertical compliance threshold. In this way, the system can prioritize the vertical compliance over the horizontal compliance by having decision block 522 processed prior to decision block 518. Conversely, the system can prioritize the horizontal compliance over the vertical compliance by having decision block 518 processed prior to decision block 522.

In some embodiments, a trained machine learning mechanism, such as an artificial intelligence model or machine learning model may be employed to generate the down-selected sources. One or more decision engines can be utilized to train artificial intelligence or machine learning models to determine which sources improve the overall horizontal and vertical compliance. Such artificial intelligence or machine learning models may be trained using several real-world location sources, along with actual location measurements and their uncertainty values. The training may involve teaching, for example, a neural network how to select sources relative to horizontal and vertical compliance thresholds using embodiments described herein and the location uncertainties from multiple sources. The artificial intelligence or machine learning models may also be trained using past location data (e.g., using simulated or actual horizontal location information and actual vertical location information for previous test calls), historical location data, crowd-sourced location data, and real-time location data to enhance its decision-making. In some embodiments, a map can also be used to improve the training of the artificial intelligence or machine learning models. For example, consecutive location data can be correlated to make subsequent decisions more accurate, mapping tools can exclude impossible or improbable locations of using location-based services (e.g., impossible or improbably location of making a 911 call). In various embodiments, the decision engines (e.g., the trained artificial intelligence or machine learning models) may be tested to verify that they collectively meet the location accuracy compliance requirements (e.g., as set by the FCC).

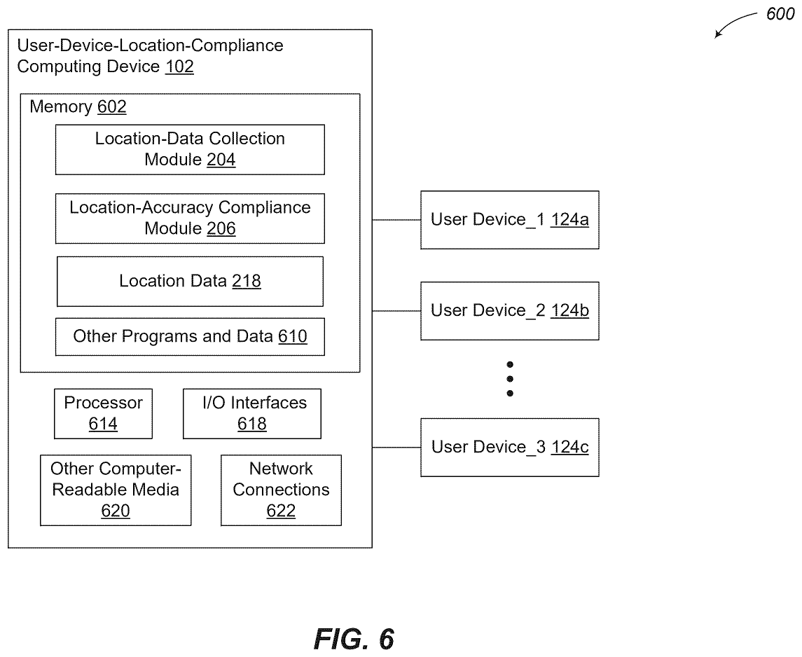

FIG. 6 shows a system diagram that describe various implementations of computing systems for implementing embodiments described herein. System 600 includes a user-device-location-compliance computing device 102 and user devices 124a-124c.

The user-device-location-compliance computing device 102 is a computing system or environment that obtains, receives, or collects location data of user devices 124a-124c that are using location-based services (e.g., making 911 calls) and dynamically selects specific location sources to improve the overall compliance of the location data, as described herein. One or more special-purpose computing systems may be used to implement the user-device-location-compliance computing device 102. Accordingly, various embodiments described herein may be implemented in software, hardware, firmware, or in some combination thereof. The user-device-location-compliance computing device 102 includes memory 602, processor 614, I/O interfaces 618, other computer-readable media 620, and network connections 622.

Processor 614 includes one or more processors, one or more processing units, programmable logic, circuitry, or one or more other computing components that are configured to perform embodiments described herein or to execute computer instructions to perform embodiments described herein. In some embodiments, a processor system of the user-device-location-compliance computing device 102 may include a single processor 614 that operates individually to perform actions. In other embodiments, a processor system of the user-device-location-compliance computing device 102 may include a plurality of processors 614 that operate to collectively perform actions, such that one or more processors 614 may operate to perform some, but not all, of such actions. Reference herein to “a processor system” of the user-device-location-compliance computing device 102 refers to one or more processors 614 that individually or collectively perform actions. And reference herein to “the processor system” of the user-device-location-compliance computing device 102 refers to 1) a subset or all of the one or more processors 614 comprised by “a processor system” of the user-device-location-compliance computing device 102 and 2) any combination of the one or more processors 614 comprised by “a processor system” of the user-device-location-compliance computing device 102 and one or more other processors 614.

Memory 602 may include one or more various types of non-volatile and/or volatile storage technologies. Examples of memory 602 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 602 may be utilized to store information, including computer-readable instructions that are utilized by processor 614 to perform actions, including embodiments described herein.

Memory 602 may have stored thereon location-data collection module 204 and location-accuracy compliance module 206. The location-data collection module 204 is configured to receive location data 218 from user devices 124a-124c for using location-based services. The location-accuracy compliance module 206 is configured to down-select location sources from which horizontal location data and vertical location data can be selected as the captured location data for a corresponding user device, as described herein. Memory 602 may also store location data 218 and other programs and data 610 (e.g., operating systems, user device data, etc.)

Network connections 622 are configured to communicate with other computing devices, such as user devices 124a-124c. In various embodiments, the network connections 622 include transmitters and receivers (not illustrated) to send and receive data as described herein. I/O interfaces 618 may include one or more data input or output interfaces, video or display interfaces, or other input/output interfaces. Other computer-readable media 620 may include other types of stationary or removable computer-readable media, such as removable flash drives, external hard drives, or the like.

The user devices 124a-124c may include computing components similar to user-device-location-compliance computing device 102, but are not shown in FIG. 6 for case of discussion.

The following is a summarization of the original claims as filed.

A method may be summarized as comprising: obtaining, from a plurality of sources, horizontal location data and vertical location data of a user device using a location-based service via a cellular communications network; for each corresponding source of the plurality of sources: determining a horizontal location uncertainty of the horizontal location data for the corresponding source; determining a vertical location uncertainty of the vertical location data for the corresponding source; generating a horizontal compliance value for the corresponding source by employing horizontal decision parameters on the horizontal location uncertainty relative to a threshold horizontal uncertainty; generating a vertical compliance value for the corresponding source by employing vertical decision parameters on the vertical location uncertainty relative to a threshold vertical uncertainty; determining an a-posteriori horizontal compliance for the corresponding source based on a combination of an a-priori horizontal compliance and the horizontal compliance value; and determining an a-posteriori vertical compliance for the corresponding source based on a combination of an a-priori vertical compliance and the vertical compliance value; and down-selecting the plurality of sources based on the a-posteriori horizontal compliance and the a-posteriori vertical compliance for each corresponding source of the plurality of sources in view of a horizontal compliance threshold and a vertical compliance threshold.

The method may further comprise: selecting a source from the down-selected sources; and selecting the horizontal location data and the vertical location data from selected source as captured location data for the user device for the location-based service based on the threshold horizontal uncertainty and the threshold vertical uncertainty.

The method may further comprise: selecting the threshold horizontal uncertainty; and selecting the threshold vertical uncertainty.

The method may further comprise: selecting the horizontal compliance threshold; and selecting the vertical compliance threshold.

The method may further comprise: defining the horizontal decision parameters as first Boolean flag decisions to generate the horizontal compliance value; and defining the vertical decision parameters as second Boolean flag decisions to generate the vertical compliance value.

The method may further comprise: generating the a-priori horizontal compliance based on a combination of horizontal location uncertainty compliances for a plurality of previously selected source; and obtaining the a-priori vertical compliance based on a combination of vertical location uncertainty compliances for the plurality of previously selected source.

The method may further comprise: updating the a-priori horizontal compliance based on the a-posteriori horizontal compliance for the selected source; and updating the a-priori vertical compliance based on the a-posteriori vertical compliance for the selected source.

A computing system may be summarized as comprising: a memory configured to store computer instructions; and a processor system configured to execute the computer instructions to: obtain, from a plurality of sources, horizontal location data and vertical location data of a user device using a location-based service via a cellular communications network; for each corresponding source of the plurality of sources: determine a horizontal location uncertainty of the horizontal location data for the corresponding source; determine a vertical location uncertainty of the vertical location data for the corresponding source; determine an a-posteriori horizontal compliance for the corresponding source based on a combination of an a-priori horizontal compliance and a horizontal compliance value derived from compliance of the horizontal location uncertainty with a threshold horizontal uncertainty; and determine an a-posteriori vertical compliance for the corresponding source based on a combination of an a-priori vertical compliance and a vertical compliance value derived from compliance of the vertical location uncertainty with a threshold vertical uncertainty; and down-select the plurality of sources based on the a-posteriori horizontal compliance and the a-posteriori vertical compliance for each corresponding source of the plurality of sources in view of a horizontal compliance threshold and a vertical compliance threshold.

The processor system of the computing system may be configured to further execute the computer instructions to: generate the horizontal compliance value for the corresponding source by employing horizontal decision parameters on the horizontal location uncertainty relative to the threshold horizontal uncertainty; and generate the vertical compliance value for the corresponding source by employing vertical decision parameters on the vertical location uncertainty relative to the threshold vertical uncertainty.

The processor system of the computing system may be configured to further execute the computer instructions to: select a source from the down-selected sources; and select the horizontal location data and the vertical location data from selected source as captured location data for the user device for the location-based service based on the threshold horizontal uncertainty and the threshold vertical uncertainty.

The processor system of the computing system may be configured to further execute the computer instructions to: select the threshold horizontal uncertainty; and select the threshold vertical uncertainty.

The processor system of the computing system may be configured to further execute the computer instructions to: select the horizontal compliance threshold; and select the vertical compliance threshold.

The processor system of the computing system may be configured to further execute the computer instructions to: define the horizontal decision parameters as first Boolean flag decisions to generate the horizontal compliance value; and define the vertical decision parameters as second Boolean flag decisions to generate the vertical compliance value.

The processor system of the computing system may be configured to further execute the computer instructions to: generate the a-priori horizontal compliance based on a combination of horizontal location uncertainty compliances for a plurality of previously selected sources; and obtain the a-priori vertical compliance based on a combination of vertical location uncertainty compliances for the plurality of previously selected sources.

The processor system of the computing system may be configured to further execute the computer instructions to: update the a-priori horizontal compliance based on the a-posteriori horizontal compliance for the selected source; and update the a-priori vertical compliance based on the a-posteriori vertical compliance for the selected source.

A non-transitory computer-readable medium may be summarized as storing computer instructions that, when executed by at least one processor, cause the at least one processor to perform actions, the actions comprising: obtaining, from a plurality of sources, horizontal location data and vertical location data of a user device using a location-based service via a cellular communications network; for each corresponding source of the plurality of sources: determining a horizontal location uncertainty of the horizontal location data for the corresponding source; determining a vertical location uncertainty of the vertical location data for the corresponding source; generating a horizontal compliance value for the corresponding source by employing horizontal decision parameters on the horizontal location uncertainty relative to a threshold horizontal uncertainty; generating a vertical compliance value for the corresponding source by employing vertical decision parameters on the vertical location uncertainty relative to a threshold vertical uncertainty; determining an a-posteriori horizontal compliance for the corresponding source based on a combination of an a-priori horizontal compliance and the horizontal compliance value; and determining an a-posteriori vertical compliance for the corresponding source based on a combination of an a-priori vertical compliance and the vertical compliance value; down-selecting the plurality of sources based on the a-posteriori horizontal compliance and the a-posteriori vertical compliance for each corresponding source of the plurality of sources in view of a horizontal compliance threshold and a vertical compliance threshold; selecting a source from the down-selected sources; and selecting the horizontal location data and the vertical location data from selected source as captured location data for the user device for the location-based service based on the threshold horizontal uncertainty and the threshold vertical uncertainty.

The computer instructions stored on the non-transitory computer-readable medium, when executed by the at least one processor, may cause the at least one processor to perform further actions, the further actions comprising: selecting the threshold horizontal uncertainty; selecting the threshold vertical uncertainty; selecting the horizontal compliance threshold; and selecting the vertical compliance threshold.

The computer instructions stored on the non-transitory computer-readable medium, when executed by the at least one processor, may cause the at least one processor to perform further actions, the further actions comprising: defining the horizontal decision parameters as first Boolean flag decisions to generate the horizontal compliance value; and defining the vertical decision parameters as second Boolean flag decisions to generate the vertical compliance value.

The computer instructions stored on the non-transitory computer-readable medium, when executed by the at least one processor, may cause the at least one processor to perform further actions, the further actions comprising: generating the a-priori horizontal compliance based on a combination of horizontal location uncertainty compliances for a plurality of previously selected source; and obtaining the a-priori vertical compliance based on a combination of vertical location uncertainty compliances for the plurality of previously selected source.

The computer instructions stored on the non-transitory computer-readable medium, when executed by the at least one processor, may cause the at least one processor to perform further actions, the further actions comprising: updating the a-priori horizontal compliance based on the a-posteriori horizontal compliance for the selected source; and updating the a-priori vertical compliance based on the a-posteriori vertical compliance for the selected source.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining, from a plurality of sources, horizontal location data and vertical location data of a user device using a location-based service via a cellular communications network;
for each corresponding source of the plurality of sources:
determining a horizontal location uncertainty of the horizontal location data for the corresponding source;
determining a vertical location uncertainty of the vertical location data for the corresponding source;
generating a horizontal compliance value for the corresponding source by employing horizontal decision parameters on the horizontal location uncertainty relative to a threshold horizontal uncertainty;
generating a vertical compliance value for the corresponding source by employing vertical decision parameters on the vertical location uncertainty relative to a threshold vertical uncertainty;
determining an a-posteriori horizontal compliance for the corresponding source based on a combination of an a-priori horizontal compliance and the horizontal compliance value; and
determining an a-posteriori vertical compliance for the corresponding source based on a combination of an a-priori vertical compliance and the vertical compliance value; and
down-selecting the plurality of sources based on the a-posteriori horizontal compliance and the a-posteriori vertical compliance for each corresponding source of the plurality of sources in view of a horizontal compliance threshold and a vertical compliance threshold.

2. The method of claim 1, further comprising:
selecting a source from the down-selected sources; and
selecting the horizontal location data and the vertical location data from selected source as captured location data for the user device for the location-based service based on the threshold horizontal uncertainty and the threshold vertical uncertainty.

3. The method of claim 1, further comprising:
selecting the threshold horizontal uncertainty; and
selecting the threshold vertical uncertainty.

4. The method of claim 1, further comprising:
selecting the horizontal compliance threshold; and
selecting the vertical compliance threshold.

5. The method of claim 1, further comprising:
defining the horizontal decision parameters as first Boolean flag decisions to generate the horizontal compliance value; and
defining the vertical decision parameters as second Boolean flag decisions to generate the vertical compliance value.

6. The method of claim 1, further comprising:
generating the a-priori horizontal compliance based on a combination of horizontal location uncertainty compliances for a plurality of previously selected source; and
obtaining the a-priori vertical compliance based on a combination of vertical location uncertainty compliances for the plurality of previously selected source.

7. The method of claim 1, further comprising:
updating the a-priori horizontal compliance based on the a-posteriori horizontal compliance for the selected source; and
updating the a-priori vertical compliance based on the a-posteriori vertical compliance for the selected source.

8. A computing system, comprising:
a memory configured to store computer instructions; and
a processor system configured to execute the computer instructions to:
obtain, from a plurality of sources, horizontal location data and vertical location data of a user device using a location-based service via a cellular communications network;
for each corresponding source of the plurality of sources:
determine a horizontal location uncertainty of the horizontal location data for the corresponding source;
determine a vertical location uncertainty of the vertical location data for the corresponding source;
determine an a-posteriori horizontal compliance for the corresponding source based on a combination of an a-priori horizontal compliance and a horizontal compliance value derived from compliance of the horizontal location uncertainty with a threshold horizontal uncertainty; and
determine an a-posteriori vertical compliance for the corresponding source based on a combination of an a-priori vertical compliance and a vertical compliance value derived from compliance of the vertical location uncertainty with a threshold vertical uncertainty; and
down-select the plurality of sources based on the a-posteriori horizontal compliance and the a-posteriori vertical compliance for each corresponding source of the plurality of sources in view of a horizontal compliance threshold and a vertical compliance threshold.

9. The computing system of claim 8, wherein the processor system is configured to further execute the computer instructions to:
generate the horizontal compliance value for the corresponding source by employing horizontal decision parameters on the horizontal location uncertainty relative to the threshold horizontal uncertainty; and
generate the vertical compliance value for the corresponding source by employing vertical decision parameters on the vertical location uncertainty relative to the threshold vertical uncertainty.

10. The computing system of claim 8, wherein the processor system is configured to further execute the computer instructions to:
select a source from the down-selected sources; and
select the horizontal location data and the vertical location data from selected source as captured location data for the user device for the location-based service based on the threshold horizontal uncertainty and the threshold vertical uncertainty.

11. The computing system of claim 8, wherein the processor system is configured to further execute the computer instructions to:
select the threshold horizontal uncertainty; and
select the threshold vertical uncertainty.

12. The computing system of claim 8, wherein the processor system is configured to further execute the computer instructions to:
select the horizontal compliance threshold; and
select the vertical compliance threshold.

13. The computing system of claim 8, wherein the processor system is configured to further execute the computer instructions to:
define the horizontal decision parameters as first Boolean flag decisions to generate the horizontal compliance value; and
define the vertical decision parameters as second Boolean flag decisions to generate the vertical compliance value.

14. The computing system of claim 8, wherein the processor system is configured to further execute the computer instructions to:
generate the a-priori horizontal compliance based on a combination of horizontal location uncertainty compliances for a plurality of previously selected sources; and
obtain the a-priori vertical compliance based on a combination of vertical location uncertainty compliances for the plurality of previously selected sources.

15. The computing system of claim 8, wherein the processor system is configured to further execute the computer instructions to:
update the a-priori horizontal compliance based on the a-posteriori horizontal compliance for the selected source; and
update the a-priori vertical compliance based on the a-posteriori vertical compliance for the selected source.

16. A non-transitory computer-readable medium storing computer instructions that, when executed by at least one processor, cause the at least one processor to perform actions, the actions comprising:
obtaining, from a plurality of sources, horizontal location data and vertical location data of a user device using a location-based service via a cellular communications network;
for each corresponding source of the plurality of sources:
determining a horizontal location uncertainty of the horizontal location data for the corresponding source;
determining a vertical location uncertainty of the vertical location data for the corresponding source;
generating a horizontal compliance value for the corresponding source by employing horizontal decision parameters on the horizontal location uncertainty relative to a threshold horizontal uncertainty;
generating a vertical compliance value for the corresponding source by employing vertical decision parameters on the vertical location uncertainty relative to a threshold vertical uncertainty;
determining an a-posteriori horizontal compliance for the corresponding source based on a combination of an a-priori horizontal compliance and the horizontal compliance value; and
determining an a-posteriori vertical compliance for the corresponding source based on a combination of an a-priori vertical compliance and the vertical compliance value;
down-selecting the plurality of sources based on the a-posteriori horizontal compliance and the a-posteriori vertical compliance for each corresponding source of the plurality of sources in view of a horizontal compliance threshold and a vertical compliance threshold;
selecting a source from the down-selected sources; and
selecting the horizontal location data and the vertical location data from selected source as captured location data for the user device for the location-based service based on the threshold horizontal uncertainty and the threshold vertical uncertainty.

17. The non-transitory computer-readable medium of claim 16, wherein the computer instructions, when executed by the at least one processor, cause the at least one processor to perform further actions, the further actions comprising:
selecting the threshold horizontal uncertainty;
selecting the threshold vertical uncertainty;
selecting the horizontal compliance threshold; and
selecting the vertical compliance threshold.

18. The non-transitory computer-readable medium of claim 16, wherein the computer instructions, when executed by the at least one processor, cause the at least one processor to perform further actions, the further actions comprising:
defining the horizontal decision parameters as first Boolean flag decisions to generate the horizontal compliance value; and
defining the vertical decision parameters as second Boolean flag decisions to generate the vertical compliance value.

19. The non-transitory computer-readable medium of claim 16, wherein the computer instructions, when executed by the at least one processor, cause the at least one processor to perform further actions, the further actions comprising:
generating the a-priori horizontal compliance based on a combination of horizontal location uncertainty compliances for a plurality of previously selected source; and
obtaining the a-priori vertical compliance based on a combination of vertical location uncertainty compliances for the plurality of previously selected source.

20. The non-transitory computer-readable medium of claim 16, wherein the computer instructions, when executed by the at least one processor, cause the at least one processor to perform further actions, the further actions comprising:
updating the a-priori horizontal compliance based on the a-posteriori horizontal compliance for the selected source; and
updating the a-priori vertical compliance based on the a-posteriori vertical compliance for the selected source.
